(19) United States
(12) Patent Application Publication
(10) Pub. No.: US 2026/0132083 A1
(43) Pub. Date: May 14, 2026

(54) FILLER MATERIAL

(71) Applicant: Laticrete International, Inc., Bethany, CT (US)

(72) Inventors: Arthur Doweyko, Durham, CT (US); Eerik Maandi, Rocky Hill, CT (US); Yunbo Chen, Woodbridge, CT (US); Rajeswari Kompalli, Bethany, CT (US)

(21) Appl. No.: 19/120,091

(22) PCT Filed: Oct. 17, 2023
(86) PCT No.: PCT/US2023/035336

§ 371 Date: Apr. 10, 2025

Related U.S. Application Data
(60) Provisional application No. 63/416,642, filed on Oct. 17, 2022.

(51) Int. Cl. C04B 28/16; C04B 7/02; C04B 7/32; C04B 11/06; C04B 11/30; C04B 14/28; C04B 16/02; C04B 16/06; C04B 22/10; C04B 22/14; C04B 24/04; C04B 28/06; C04B 103/00; C04B 103/30; C04B 103/32; C04B 103/44; C04B 103/50; C04B 103/54; C04B 103/67; C04B 111/00; C04B 111/10; C04B 111/20; C04B 111/70; C04B 111/82

(52) U.S. Cl. CPC C04B 28/16; C04B 7/02; C04B 7/32; C04B 11/06; C04B 11/30; C04B 14/28; C04B 16/02; C04B 16/0675; C04B 22/10; C04B 22/147; C04B 24/04; C04B 28/06; C04B 2103/0052; C04B 2103/302; C04B 2103/32; C04B 2103/44; C04B 2103/50; C04B 2103/54; C04B 2103/67; C04B 2111/00689; C04B 2111/1056; C04B 2111/2038; C04B 2111/70; C04B 2111/82

(57) ABSTRACT

The invention is directed to one or more sand free cement-based grout compositions that are highly resistant to wet abrasion removal. The one or more sand free cement-based grout compositions comprising calcium aluminate cement as a main binder in combination with one or more additional binders as well as one or more of the following ingredients: a single anhydrite binder, metakaolin, fine limestone, coarse limestone, an acidic retarder, and/or a lithium-based accelerator. The invention is directed to one or more methods of wet abrasion testing cured and wetted sand free cement-based grout compositions.

### TECHNICAL FIELD

The present invention relates generally to construction materials and, more particularly, to a filler material for filling spaces or joints between ceramic tiles or mosaics after installation.

### DESCRIPTION OF RELATED ART

In tile installation processes after tiles are adhered to a substrate (e.g., a floor, wall, counter, etc.) a grout material is typically filled into openings or joints residing between adjacent tiles. Grout is also used in various applications including pressure grouting, embedding rebar in masonry walls, connecting sections of pre-cast concrete, filling voids, sealing joints, and the like. There are a variety of tile grout compounds, such as, acrylic grouts, epoxy grouts, and Portland and regular cement-based grouts. Regardless of the grout type, all are expected to provide certain properties. These properties include workability, stain resistance, forming a full grout fill within the spaces, have uniform appearance and/or color, and are easy to cleanup with a minimum amount of water.

Abrasion resistance is another important tile grout property. Abrasion resistance is the ability of the cured tile grout surface to resist being worn away by rubbing or friction. It is particularly dependent on good curing but also relies on other factors including materials and surface finishing, aggregate hardness, mix proportions, aggregate/paste bond, and placing and compaction. To determine abrasion resistance, testing is performed by scraping, scouring or digging into the top surface of the cured tile grout with a hard object (e.g., spatula, ordinary screwdriver, etc.). The amount of grout material scrapped off or scoured/dug out from the abrasion test provides an estimate of potential wear resistance and durability of the cured grout.

While epoxy grouts have a much higher resistance to abrasion and staining, as compared to cement based grouts, they do not have good workability or ease of cleanup. As such, field installers typically prefer cement-based grouts. Cement based grouts are generally composed of a powdered mix of cement, lime, color pigment and sometimes sand that hardens when mixed with water and left to cure. Examples of cement-based grouts include Portland and regular cement-based grouts. These types of grouts are preferred as they provide easy workability as compared to non-cement-based grouts (e.g., epoxy grouts). Workability is an important tile grout property since it directly affects the ease of grouting, cleanup, and reduces costs since less labor is required to perform a tile grout job.

The ease of workability and clean-up of cement-based grouts continues to make them preferred grouting materials. However, when cement-based grouts are used, the grouts tend to crack easily and stain over time. Cement based grouts also develop poor strength under dry conditions or over time, leading to wear, scratching, and/or loss of grout material due to abrasion, rubbing or friction. As a result, owners usually have to re-grout tiles, which is expensive and time consuming. Accordingly, there continues to be a need for new and improved cement-based grouts for which the present invention provides a solution thereto.

### SUMMARY OF THE INVENTION

Bearing in mind the problems and deficiencies of the prior art, it is therefore an object of the present invention to provide a sand free grout compositions that cure fully and retain water both during and after curing to form grout joints that are highly resistant to wet abrasion techniques.

Another object of the present invention is to provide grout compositions that avoid water or moisture loss before, during and after curing.

It is another object of the present invention to provide methods for using the tile grout in the installation of ceramic tiles and other tiles.

In one or more embodiments, the invention is directed to sand free cement-based grout compositions comprising calcium aluminate cement as a main binder present in an amount ranging from about 22-24 wt. %; one or more additional binders present in an amount ranging from about 10-14 wt. %; a single anhydrite binder present in an amount ranging from about 7-9 wt. %; metakaolin present in an amount ranging from about 1.5-2.5 wt. %; fine limestone present in an amount ranging from about 10-20 wt. %; coarse limestone present in an amount ranging from about 25-45 wt. %; an acidic retarder present in an amount ranging from about 0.30-0.60 wt. %; and a lithium-based accelerator present in an amount ranging from about 0.05-0.20 wt. %, wherein wt. % is based on a total weight of the grout composition.

In one or more other embodiments, the invention is directed to methods of wet abrasion testing cured and wetted sand free cement-based grout compositions.

Still other objects and advantages of the invention will in part be obvious and will in part be apparent from the specification.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 is a depiction of potential areas of water loss in a cured grout joint.

FIGS. 2A and 2B show prior art grout joints after having undergone wet abrasion scratch testing and digging testing, respectively.

FIGS. 3A and 3B show additional prior art grout joints after having undergone wet abrasion scratch testing and digging testing, respectively.

FIGS. 4A and 4B show grout compositions and grout joints of the invention after respectively undergoing wet abrasion scratch testing and digging testing.

FIGS. 5A and 5B show other grout compositions and grout joints of the invention after respectively undergoing wet abrasion scratch testing and digging testing.

FIGS. 6A and 6B show still other grout compositions and grout joints of the invention after respectively undergoing wet abrasion scratch testing and digging testing.

FIG. 7 depicts graphed 24-hour compression strength measures of grout compositions of the invention.

FIG. 8 depicts graphed 28-day compressive strength measures of grout compositions of the invention.

FIG. 9 depicts graphed 28-day tensile strength measures of grout compositions of the invention.

FIG. 10 depicts graphed 28-day flexural strength measures of grout compositions of the invention.

FIG. 11 depicts graphed 28-day linear shrinkage percentages of grout compositions of the invention.

FIG. 12 depicts graphed 28-day water absorption percentages of grout compositions of the invention.

FIGS. 13A and 13B depict graphed 3-day wet abrasion scratch testing and dig testing, respectively, of the present grout compositions.

FIG. 14 is a chart showing ingredients and amounts thereof in the various grout compositions of the present invention.

FIGS. 15A-15C illustrate images of wet scratch abrasion test methods for comparative testing of the present grout formulations as compared to prior art cement grouts.

FIGS. 16A-16D illustrate images of grading wet abrasion amounts of the tests of FIGS. 15A-15C.

FIGS. 17A-17C illustrate images of wet abrasion testing using a strength tester for comparative testing of the present grout formulations as compared to prior art cement grouts.

FIGS. 18A-18E illustrate additional images of wet abrasion testing using a strength tester for comparative testing of the present grout formulations as compared to prior art cement grouts.

FIGS. 19A-19B illustrate images of comparative wet scratch abrasion tests and wet abrasion testing using a strength tester for grout compositions of the invention as compared to prior art cement grouts.

### MODE(S) FOR CARRYING OUT INVENTION

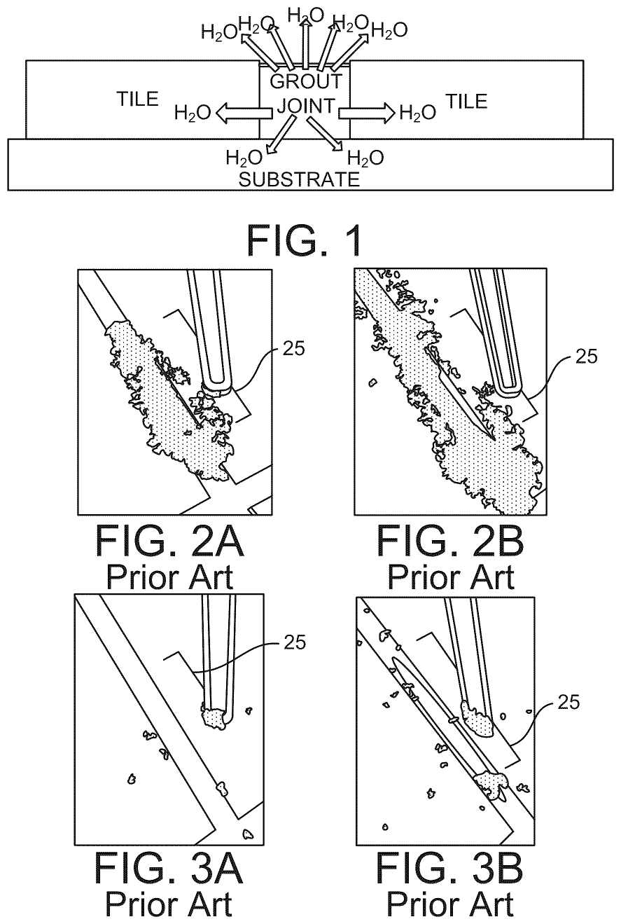

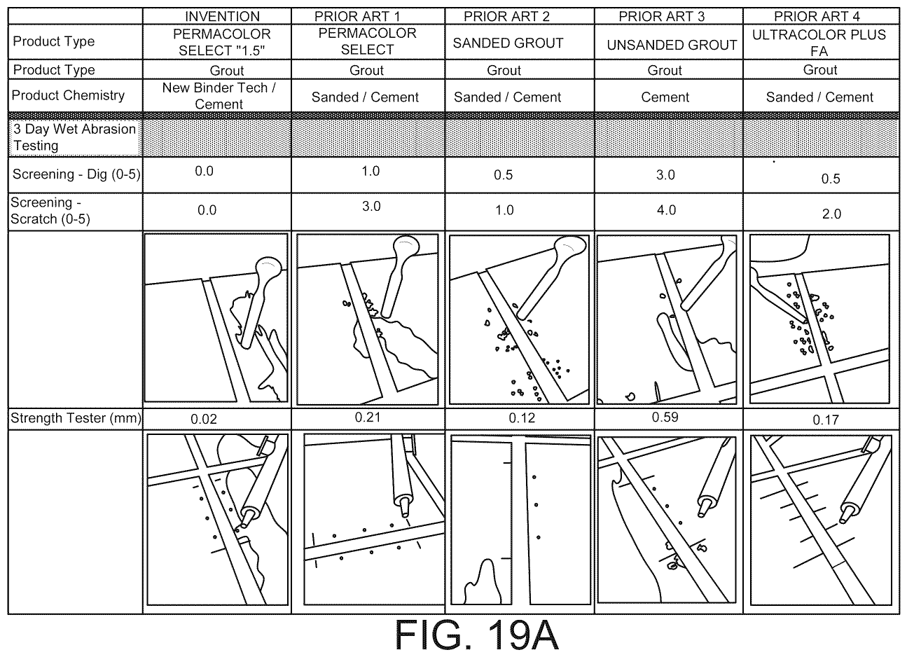

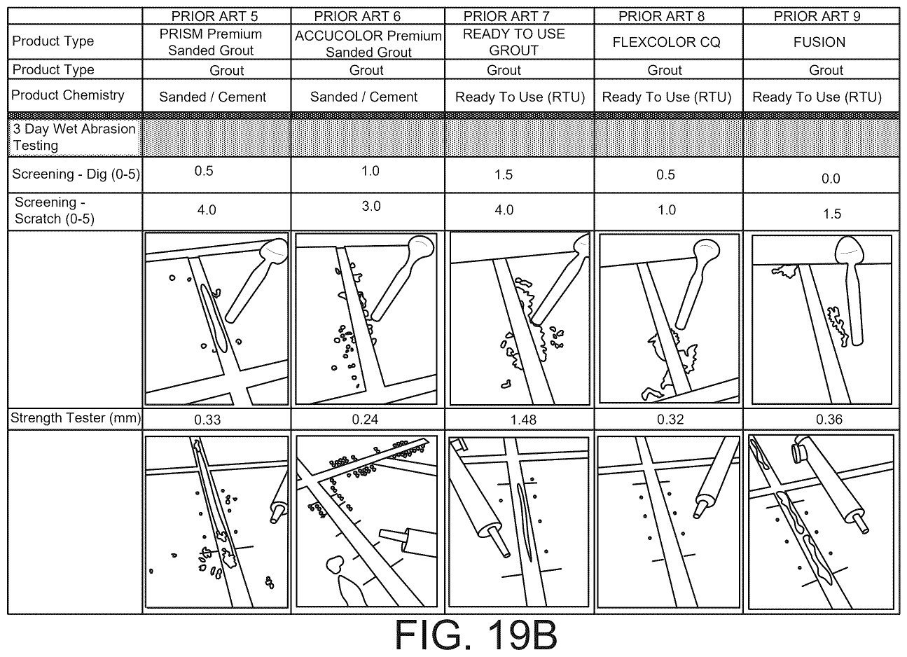

In describing the preferred embodiment of the present invention, reference will be made herein to FIGS. 1-19B of the drawings in which like numerals refer to like features of the invention.

The embodiments of the present invention can comprise, consist of, and consist essentially of the features and/or steps described herein, as well as any of the additional or optional ingredients, components, steps, or limitations described herein or would otherwise be appreciated by one of skills in the art. It is to be understood that all concentrations disclosed herein are by weight percent (wt. %.) based on a total weight of the composition or formulations being made, unless otherwise indicated.

The various embodiments of the invention provide cement-based grouts having improved and increased abrasion resistance. It has been found that in wet cement-based grouts, the water component needs to remain in the grout material and be trapped within the filled joint in order for a full cure to take place throughout the entire grout joint. Yet, referring to FIG. 1, it has been found that water is lost to absorption by the adjacent tiles or underlying substrate, and/or evaporated into the air above exposed surfaces of the cement grout joint. As such, the filled grout joint does not retain enough water to fully cure. Further, when wetted or contacted with water after the cement grout joint has cured, the grout may become “soft” and is easily scrapped out of the grout joint, regardless of how much time has passed since the grout was installed and cured.

In accordance with the invention, factors impacting abrasion, including the increase or decrease thereof, were determined by formulating conventional cement-based grout compositions and performing abrasion testing on the cured products. The tested conventional cement-based grout composition contained main ingredients including fine sand as the main aggregate, white calcium aluminate cement, white Ordinary Portland Cement, and calcium sulfate, as well as other ingredients to provide the grout with desired attributes and/or characteristics. After preparation, a number of sample sets of cured grout joints were formed by applying the cement-based grout into joints between adjacent 4×4 inch tiles to a thickness of about ⅜ inch thick. Each sample set (i.e., mocked up test set) was allowed to cure for 3 days and tested under different conditions, as described below, to determine the impacts thereof on the resultant cure state of the different cement tile joints.

In a first of the cement tile grout sample sets, curing occurred over a 3-day period followed by spraying the cement tile joint with water at various times. For the second cement grout sample, curing occurred over a 3-day period followed by applying a water-wash containing lithium hydroxide. The third cement tile grout sample set was cured over a 3-day period and was sprayed after it was washed. The fourth cement tile grout sample set was cured over a 3-day period followed by submerging the sample in water for 24 hours.

Wet abrasion testing was then performed on the four sample sets and ranked with a grading system ranging from 0-5, with a “0” rank indicating no scratches occurring in the sample surface, and a “5” rank indicating that the grout was almost entirely removed from the grout joint. The abrasion testing was performed on the cured grout joints using scratching and/or digging methods. For instance, referring to FIG. 2A, in the third sample set water was applied to the cured surface, and after a 5-minute wait period, the top surface scratched using an instrument for determining an amount of grout material removed. FIG. 2B shows the digging wet abrasion test performed on another section (or a separate set) of the third sample set. Upon wet abrasion testing, the first, second and third sample sets were given abrasion ranks of “3's” or “4's” indicating a significant amount of cement grout was removed from the tile joint. The fourth sample set, which was submerged in water for 24 hours, was ranked a “0” indicating that no cement grout was removed from the tile joint.

Based on the foregoing sample set wet abrasion tests, it was concluded that water retention within the grout is essential to improve wet abrasion resistance. In the first through third samples having ranks of “3's” or “4's” it was found that the formed grout joints did not retain the necessary amounts of moisture/water within the composition while curing. Referring to FIG. 1, water/moisture was lost during and/or after curing as a result of absorption from the surrounding tiles and substrate as well as due to evaporation at the exposed top surface. This lost water prevents the cement grout from fully curing throughout the entire tile joint, resulting in a weaker tile joint that is easily scratched and/or dug out. Further, it has been found that in the sample sets tested, upon briefly applying water or moisture to the grout joints, the main ingredients of the grout composition soften upon wetting as the grout was trying to complete cure. This softness prevents the grout from fully curing and results in a grout joint that is easily scratched or dug out.

In accordance with the invention, it has been found that by keeping water in the grout composition before, during, and after curing improves abrasion resistance. In particular, the fourth sample set was submerged in water for 24 hours after the 3-day cure, and when wet abrasion tested, it was ranked a “0” indicating no cement grout was removed from the tile joint. By adding water back into the cement grout joint, the surface of the joint was resistant to scratching and digging. As another example, a fifth sample set of the above grout composition was applied between tiles and allowed to cure for 3 days. Similar to that of the third sample set shown in FIGS. 2A-B, after a 3-day cure period the sample set was sprayed with water, however, once wetted this set was covered

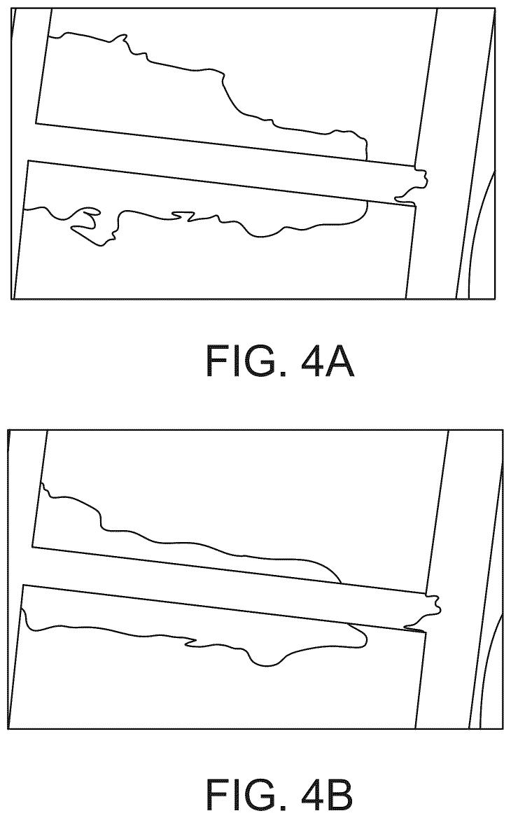

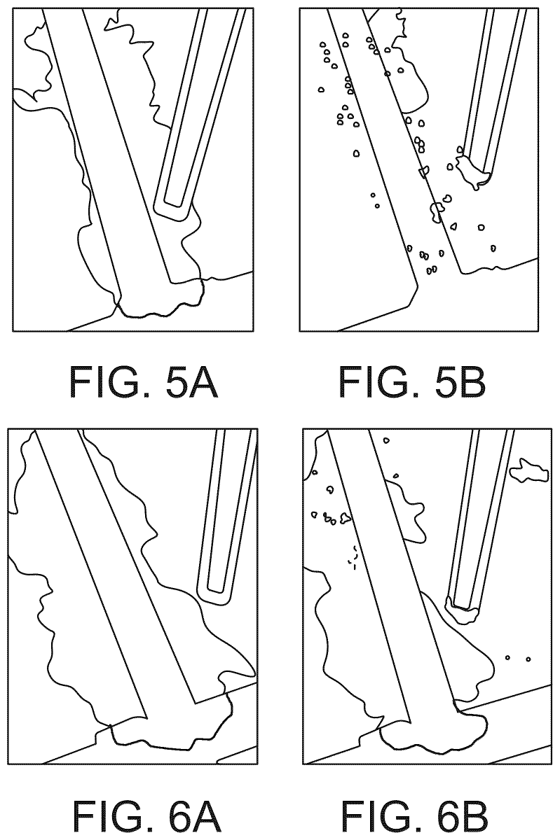

with a plastic sheet for 24 hours to trap the water and moisture therein. After the 24 hours, wet abrasion testing was performed by scratching (see, FIG. 3A) and by digging (see, FIG. 3B). By covering the surface with plastic and allowing the water to saturate into the grout joint, the cement grout was fully wetted and exhibited increased resistance to scratching (see, FIGS. 3A-B) as compared to the third sample set which was not covered with plastic (see, FIGS. 2A-B). Similar tests were performed on cement grouted tile sets that had been cured for months and were known to fail the wet abrasion tests. Once these older cured sets were wetted and covered with plastic for 24 hours, the grout joints had increased strength and resistance to abrasion/scratching.

In accordance with the invention, it has been found that known grout compositions containing fine sand as the main aggregate, in combination with calcium aluminate cement, Ordinary Portland Cement, and calcium sulfate, may not completely cure due to moisture or water loss in the grout as it cures. They are also susceptible to degradation (i.e., softening) due to wetting of the cured tile grout joint. In accordance with the invention, it has also been found that a primary ingredient contributing to increased moisture loss and incomplete or defective curing is the sand that is used as the main aggregate within these known grout compositions. During curing of the known ternary binder system (i.e., calcium aluminate—Portland Cement—calcium sulfate), the sand caused this ternary binder system to not retain enough moisture, resulting in a weaker surface area of the known cured grout product (tile joint). While not meant to be limiting, it is believed that the particle shape and size of the fine sand contributes to a very compact grout in the filled joint that hinders the composition's ability to both absorb and retain water during and after cure.

Also in the invention, it has been found that entirely eliminating the sand, particularly fine sand, and replacing it with a coarse limestone, along with other modifications to the ingredients and amounts thereof, enables the cement grout compositions of the invention to maintain water and/or moisture therein for providing cured grout joints having increased resistance to abrasion (e.g., scratching, digging, etc.). The present cement-based grout compositions are silica free (silica sand free), resistant to wet abrasion (i.e., can withstand wet abrasion testing), and meet ANSI A118.7

High Performance Cement Grout standards. It has been found that in the present sand-free cement grout compositions, the chemical and physical characteristics (e.g., malleability) of the coarse limestone provides the necessary aggregate strength similar to that of silica sand, while also allowing for increased absorption and retention of water as compared to lower absorption and water retention measures associated with known silica sand-based grouts. In addition to the increased absorption and water retention measures, the present silica free cement-based grouts are also able to fully cure, and the coarse limestone main aggregate packs the grout joint tightly due to its malleability. This increased packing of the grout joint further allows for better retention of water and full curing within the joint.

Referring to the various embodiments, the present cement-based grouts include one or more binder components. A first binder may be calcium aluminate cement, preferably white calcium aluminate cement, as a main binder present in an amount ranging from about 22-24 wt. %, based on a total weight of the grout composition. The cement-based grout compositions also include a cement binder present in an amount ranging from about 3-5 wt. %. In one or more embodiments the cement binder may comprise Ordinary Portland Cement, more preferably White Ordinary Portland Cement. The cement-based grout compositions may further include a third binder comprising calcium sulfate, prefer anhydrous calcium sulfate, present in an amount ranging from about 7-9 wt. %, based on a total weight of the grout composition.

The present cement-based grout compositions also include a highly reactive metakaolin (i.e., Kaolin clay or dehydroxylated form of the clay mineral kaolinite) present in an amount ranging from about 1.5-2.5 wt. %, based on a total weight of the grout composition. In one or more embodiments the highly reactive metakaolin component comprises an amorphous, alumino-silicate. A suitable metakaolin is formed by calcination of purified kaolin, and is a white, amorphous aluminum silicate that reacts aggressively with calcium hydroxide to form cementitious products. It is believed together the addition of the highly reactive metakaolin in combination with a single anhydrite source help to improve abrasion resistance of the final grout product. That is, while not meant to be limiting, in one or more embodiments the grout compositions include the reactive metakaolin in the presence of only the anhydrous calcium sulfate binder (i.e., a hemihydrate source (e.g. gypsum) is not present in the grout composition).

The grout compositions of the invention further include one or more aggregates as filler materials. A first of the aggregates includes fine crushed limestone of 325 mesh (i.e., the majority of the particles have sizes of 44 micron or 0.0017 inches). The fine 325 mesh crushed limestone may be present in an amount ranging from about 10-20 wt. %, based on a total weight of the grout composition. A second of the aggregates includes coarse limestone of 40 mesh (i.e., the majority of the particles have sizes of 417 micron or 0.0164 inches). The 40-mesh coarse limestone is present in the grout composition in an amount ranging from about 25-45 wt. %, preferably 35-45 wt. %.

In accordance with the invention, the instant grout compositions avoid use of sand, particularly, fine sand as an aggregate. It has been found that when fine sand is a main aggregate in the composition, it hinders the grout composition's ability to retain water. In particular, it is believed

that due to the particle shape and size of the sand, the ingredients within the composition were tightly compact and did not allow for any water to be absorbed or held within gaps/cavities of the grout matrix. In accordance with the invention, the grout compositions include at least coarse limestone, instead of fine sand, to provide sand-free, silica sand-free, and/or silica free grout compositions. It has been found that at least the coarse limestone helps absorb and retain water within the grout composition matrix as a result of its increased aggregate surface area, as compared to sand/silica sand. Also, the calcium carbonate in the limestone absorbs and retains water in larger amounts as compared to silica sand.

The present compositions also include one or more of a dispersible powder copolymer, an accelerator and a retarder. The dispersible powder copolymer may be used as a main polymer present in the composition in amounts ranging from about 1.5-2.5 wt. %, based on a total weight of the grout composition. The dispersible powder copolymer may be a water dispersible powdered ethylene/vinyl laurate/vinyl chloride terpolymer. The accelerator is preferably a lithium-based accelerator for triggering a reaction with the main binder constituent, or a reaction with the combination of binders in the composition. The accelerator lithium-based accelerator may be in powder form, and may be present in the grout composition in amounts ranging from about 0.05-0.20 wt. %. Suitable lithium-based accelerators include lithium sulfate or lithium carbonate. The retarder may include a powdered acid (or salt derivative) for slowing down the hydration/curing reaction. The retarder may be present in amounts ranging from about 0.30-0.60 wt. %, preferably from about 0.30 wt. % to 0.48 wt. % in certain embodiments, based on a total weight of the grout composition. Suitable powdered acid retarders may include citric acid, tartaric acid, etc.

The grout compositions of the invention also include one or more rheological modifiers. A first rheological modifier may include fibers, preferably, 3 mm (or less) long fibers composed of cellulose, starch, glass, and the like. In one or more embodiments, cellulose fibers are preferred. The fibers may be present in the grout composition in amounts ranging from about 0.25-0.75 wt. %, based on a total weight of the grout composition. The second rheological modifier may include cellulose ethers. Preferably, the second rheological modifier is a cellulose ether modifier suitable for use with cementitious materials such as, for example, modified hydroxypropyl methyl cellulose ether, hydroxypropyl ethyl cellulose ether, or a medium viscosity, non-modified methyl hydroxyethyl cellulose. The cellulose ether rheological modifier may be present in the composition in amounts ranging from about 0.05-0.10 wt. %, based on a total weight of the grout composition.

Additional ingredients within the present grout compositions may include water reducing agents and hydrophobic agents. The water reducing agents may include a super plasticizer present in an amount ranging from about 0.10-0.15 wt. %, based on a total weight of the grout composition. The water reducing super plasticizer(s) may include, for instance, polycarboxylate ether, a free-flowing spray dried powder of a modified polycarboxylic ether, melamine sulfonates, naphthalene sulfonates, lignosulfonates, and combinations thereof. The hydrophobic agents may include a powdered dispersible hydrophobic additive, particularly a hydrophobic polymer, in an amount ranging from about 0.05-0.20 wt. %, based on a total weight of the grout composition.

The grout compositions of the invention also include a defoamer, thickening agent, and an antimicrobial agent. The defoamer may be present in an amount ranging from about 0.25-0.30 wt. %, the thickening agent from about 0.01-0.02 wt. %, and the antimicrobial agent from about 0.01 -0.01 wt. %, each based on a total weight of the grout composition. The defoamer may be a powdered additive of hydrocarbons and polyglycols on an inorganic carrier. Suitable defoamers may include a blend of liquid hydrocarbons and polyglycols on an inorganic carrier, or a powder defoamer based on fatty alcohol alkoxylates and polysiloxane on an inorganic carrier material. The thickening agent is a viscosity/rheological modifier, and may be a dituan gum-based viscosity modifier.

The various grout compositions of the invention may also include antimicrobial/biocides, reinforcing fibers, and one or more colorants. For instance, present grout compositions may include a biocide in an amount ranging from about 0.005-0.02 wt. %, and reinforcing fibers in an amount ranging from about 0.005-0.02 wt. %, both based on a total weight of the grout composition. The grout compositions may also include a colorant in an amount ranging from about 0.005-6.0 wt. %, based on a total weight of the composition. Suitable colorants include black iron oxide, yellow iron oxide, red iron oxide, titanium dioxide, blue iron oxide, or green chrome oxide.

In accordance with the various embodiments, the invention provides high-performance cement grouts having high mechanical strength (i.e., 100-200 MPa), high abrasion resistance, high erosion resistance, and are able to withstand the wet abrasion test in accordance with ANSI A118.7 grout standards. The present grouts are silica-free avoiding use of silica and/or silica sand as a main aggregate, and rather implement a coarse limestone, amongst other ingredients. It has been found that by eliminating sand, and replacing it with a coarse limestone, in combination with various other ingredients and amounts thereof (e.g., addition of a pozzolanic clay, increasing Portland Cement and Calcium Sulfate content, lowering accelerator amounts, etc.), the present grouts are provided with several benefits. Benefits include, but are not limited to, providing a silica-dust free composition that eliminates air-borne contaminates, providing an increased batch-to-batch color

consistency, providing a whiter white colored grout, increasing absorption and water retention, the malleability of the limestone aggregate providing a tightly packed grout joint for further water retention and enabling a full curing of such joint, and providing a finished grout product that remains intact when wetted and avoids scratching thereof.

It has been found that water helps cement grout to fully cure within the tile joint. As such, the cement grouts of the invention have a sufficient amount of water before and during curing to enable a complete cure of the grout joint, as well as retain sufficient amounts of water after cure providing durable resultant cured grout products that withstand wet abrasion testing. The coarse limestone within the present grouts provides increased calcium carbonate aggregate surface area for absorbing and retaining water in larger amounts and more efficiently, as compared to prior art silica sand-based grouts. Also, in accordance with testing of the invention, as described in more detail below, the present grout compositions have superior compressive strengths, flexural strengths, as well as tensile strengths, as compared to conventional ternary binder silica/silica sand-based grouts. They also have improved dry abrasion strength and linear shrinkage to remain intact with minimal scratching, also as compared to conventional ternary binder silica/silica sand-based grouts (i.e., known ternary binder systems including calcium aluminate, Portland Cement, and calcium sulfate).

The grouts of the invention have superior water absorption while also being capable of retaining sufficient amounts of water to improve Wet Abrasion resistance. In particular, the present cementitious grouts are able to be tightly packed into the grout joint due to the malleability of the limestone aggregate within such compositions, as well as having excellent resistance to wet abrasion and passing all ANSI A118.7. The grouts of the invention have equivalent workability and rheology as sanded grouts, without containing fine sand aggregates (as well as not containing gypsum binder), and are therefore OSHA-compliant Respirable Silica-Free grouts.

FIGS. 4A and 4B show grout compositions of the invention in resultant cured grout joint states. The grout composition shown in these images include a composition containing coarse limestone, along with about 8 wt. % of snow-white filler, about 0.10 wt. % lithium carbonate, and about 0.35 wt. % citric acid, all based on a total weight of such grout composition. Both figures depict wet abrasion testing of such joints, whereby an initial scratch test is shown in FIG. 4A and a final dig test is shown in FIG. 4B. As shown, the coarse limestone grout compositions of the invention exhibited superior wet abrasion testing as compared to conventional grouts that include sand within such compositions, as shown in FIGS. 2A-3B.

In accordance with the invention, it was found that in addition to the coarse limestone component, various ingredients within the present grout compositions contributed to the increased resistance to wet abrasion testing of the resultant joints. In particular, it was found that providing lithium-based accelerators (e.g., lithium carbonate) in a preferred amount of about 0.10 wt. % to 0.20 wt. %, in combination with the powdered acid retarder (e.g. citric acid) in a preferred amount of about 0.30 wt. % to 0.48 wt. %, showed superior results in increasing resistance to wet abrasion testing as compared to grouts having larger amounts (i.e., weight percentages) of such ingredients. For instance, citric acid amounts over 0.60 wt. % showed decreased resistance to wet abrasion testing.

It has also been found that including a highly reactive metakaolin (i.e., Kaolin clay) in the present grout compositions increases resistance to wet abrasion testing. Referring to the drawings, FIGS. 5A and 5B depict wet abrasion scratch testing and digging tests, respectively, of a present grout composition containing no metakaolin. Improved wet abrasion scratching and digging test results of present grout compositions containing metakaolin are shown in FIGS. 6A and 6B, respectively. It was found that the metakaolin helped to lock in the water allowing for a full curing of the grout joint. In addition to the metakaolin, it was found by including a single anhydrite calcium sulfate source, as compared to two sources including an anhydrite and a hemihydrate, further improves resistance of the present grouts to wet abrasion testing.

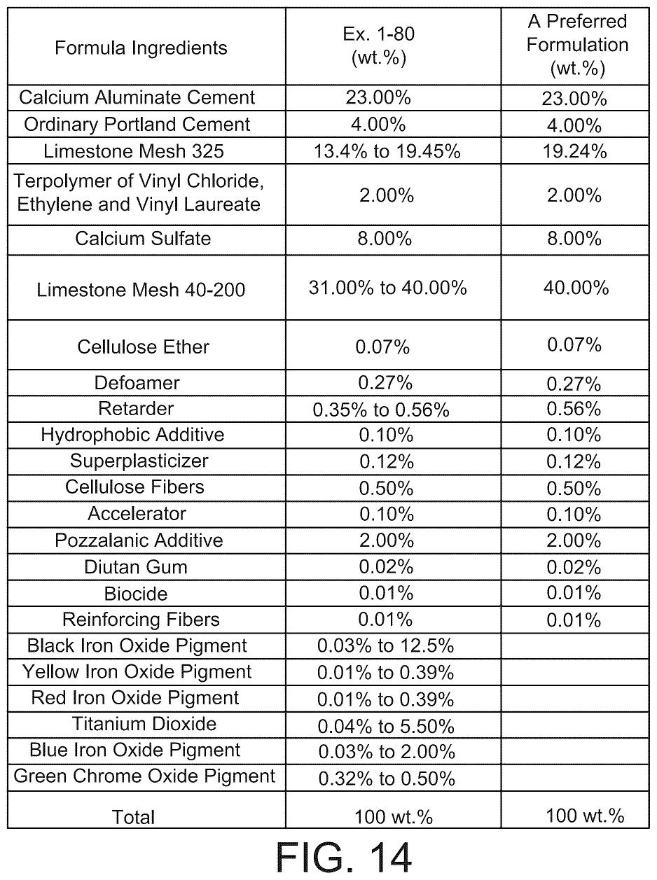

Various coarse limestone grout compositions of the invention were prepared and tested. FIG. 14 illustrates a table of the various ingredients within the 80 prepared and tested coarse limestone grout compositions of the invention. It should be appreciated that the listed ingredients are exemplary, and various embodiments of the invention may include all of such ingredients or selected combinations of the listed ingredients.

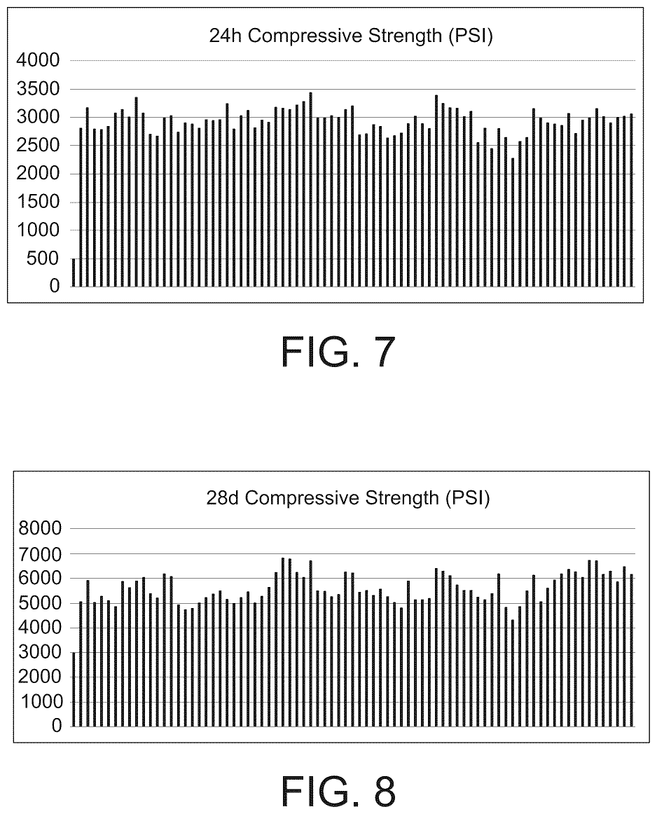

FIG. 7 depicts graphed 24-hour compression strength measures of grout compositions in accordance with the invention. The compressive strengths are measured in PSI. The ANSI A118.7.3.5 standard is 500 PSI. The results of the 24-hour compression strengths show that all grout compositions of the invention exhibited strengths well above the ANSI A118.7.3.5 standard. In the graph of FIG. 7, the plotted compression strengths measured in PSI (from left to right) are as follows: 2810, 3170, 2800, 2780, 2840, 3070, 3140, 3010, 3350, 3070, 2700, 2670, 2990, 3030, 2740, 2900, 2880, 2810, 2960, 2940, 2950, 3240, 2800, 3030, 3120, 2820, 2950, 2910, 3180, 3160, 3140, 3220, 3280, 3430, 2990, 2980, 3020, 3000, 3140, 3200, 2690, 2700, 2870, 2840, 2630, 2670, 2720, 2890, 3020, 2890, 2790, 3380, 3240, 3170, 3160, 3010, 3110, 2550, 2810, 2440, 2800, 2640, 2270, 2570, 2640, 3150, 2990, 2900, 2880, 2860, 3070, 2710, 2950, 2990, 3150, 3010, 2900, 2990, 3020, and 3060.

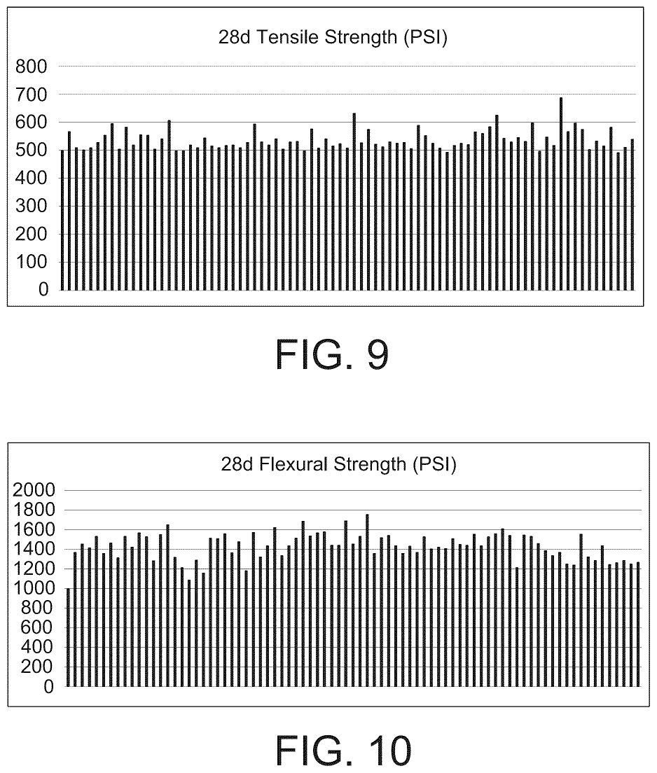

FIG. 8 depicts graphed 28-day compressive strength measures of the present grouts. The compressive strengths are measured in PSI, and obtained on several different days. The ANSI A118.7.3.5 standard is 3000 PSI as depicted in the graph. The results of the 28-day compression strengths show that all grout compositions of the invention exhibited strengths well above the ANSI A118.7.3.5 standard. In the graph of FIG. 8, the plotted compression strengths measured in PSI (from left to right) are as follows: 5060, 5920, 5040, 5280, 5100, 4880, 5880, 5620, 5910, 6050, 5390, 5225, 6180, 6090, 4940, 4750, 4790, 5020, 5240, 5370, 5500, 5150, 5000, 5240, 5470, 5020, 5280, 5640, 6250, 6810, 6770, 6230, 6060, 6710, 5510, 5480, 5260, 5360, 6270, 6210, 5450, 5530, 5310, 5560, 5260, 5040, 4810, 5890, 5130, 5120, 5200, 6410, 6290, 6120, 5750, 5520, 5530, 5240, 5120, 5390, 6190, 4830, 4330, 4860, 5500, 6140, 5050, 5610, 5930, 6200, 6370, 6270, 6050, 6740, 6715, 6180, 6300, 5870, 6460, and 6180.

FIG. 9 depicts graphed 28-day tensile strength measures of the present grouts. The tensile strengths are measured in PSI, and obtained on several different days. The ANSI A118.7.3.6 standard is 500 PSI as depicted in the graph. The results of the 28-day compression strengths show that the majority of the grout compositions exhibited tensile strengths meeting or exceeding the ANSI A118.7.3.6 standard. In the graph of FIG. 9, the plotted tensile strengths measured in PSI (from left to right) are as follows: 568, 509, 501, 510, 528, 554, 595, 506, 583, 519, 556, 554, 505, 541, 606, 500, 500, 520, 510, 545, 516, 510, 517, 520, 509, 529, 594, 530, 519, 541, 506, 531, 532, 498, 576, 508, 542, 516, 524, 508, 633, 528, 575, 522, 513, 530, 526, 529, 507, 588, 552, 526, 508, 494, 517, 526, 521, 566, 560, 584, 626, 543, 531, 546, 532, 599, 497, 548, 517, 687, 567, 598, 574, 503, 533, 515, 583, 492, 512, and 539.

FIG. 10 depicts graphed 28-day flexural strength measures of the present grouts. The flexural strengths are measured in PSI, and obtained on several different days. The ANSI A118.7.3.7 standard is 1000 PSI. The results of the 28-day flexural strengths show that all of the present grout compositions exhibited flexural strengths exceeding the ANSI A118.7.3.7 standard. In the graph of FIG. 10, the plotted tensile strengths measured in PSI (from left to right) are as follows: 1369, 1453, 1415, 1533, 1360, 1465, 1313, 1530, 1423, 1568, 1531, 1283, 1547, 1650, 1320, 1214, 1090, 1290, 1156, 1512, 1509, 1559, 1367, 1477, 1182, 1574, 1323, 1431, 1625, 1338, 1435, 1372, 1686, 1540, 1568, 1580, 1443, 1442, 1690, 1456, 1535, 1752, 1357, 1516, 1543, 1436, 1358, 1432, 1370, 1527, 1402, 1421, 1410, 1510, 1448, 1442, 1556, 1436, 1529, 1561, 1609, 1540, 1210, 1540, 1210, 1546, 1530, 1461, 1391, 1339, 1368, 1250, 1243, 1555, 1325, 1286, 1435, 1244, 1265, 1287, 1253, and 1271.

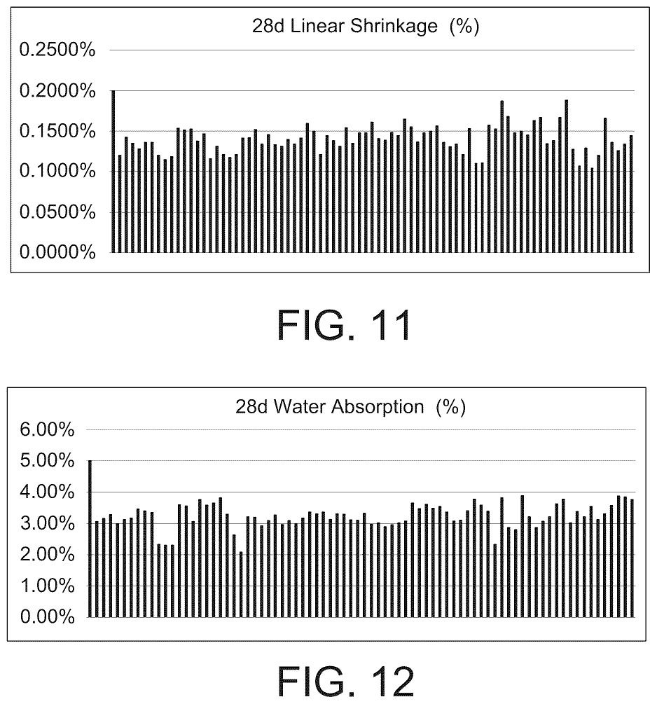

FIG. 11 depicts graphed 28-day linear shrinkage percentages of the present grouts. Linear shrinkages were obtained on several different days. The ANSI A118.7.3.3 high standard is 0.2000% as depicted in the graph. The results of the 28-day linear shrinkage percentages show that all of the present grout compositions exhibited acceptable results falling below the ANSI A118.7.3.3 standard. In the graph of FIG. 11, the plotted linear shrinkage percentages (from left to right) are as follows: 0.1205%, 0.1425%, 0.1350%, 0.1280%, 0.1365%, 0.1365%, 0.1200%, 0.1150%, 0.1190%, 0.1540%, 0.1515%, 0.1530%, 0.1380%, 0.1465%, 0.1160%, 0.1315%, 0.1215%, 0.1175%, 0.1215%, 0.1415%, 0.1420%, 0.1520%, 0.1340%, 0.1455%, 0.1335%, 0.1315%, 0.1395%, 0.1340%, 0.1415%, 0.1595%, 0.1505%, 0.1215%, 0.1450%, 0.1380%, 0.1315%, 0.1540%, 0.1355%, 0.1480%, 0.1480%, 0.1615%, 0.1410%, 0.1390%, 0.1485%, 0.1450%, 0.1650%, 0.1550%, 0.1370%, 0.1480%, 0.1505%, 0.1565%, 0.1355%, 0.1310%, 0.1335%, 0.1215%, 0.1530%, 0.1105%, 0.1115%, 0.1575%, 0.1525%, 0.1870%, 0.1675%, 0.1480%, 0.1505%, 0.1455%, 0.1635%, 0.1670%, 0.1345%, 0.1385%, 0.1670%, 0.1885%, 0.1275%, 0.1075%, 0.1295%, 0.1050%, 0.1205%, 0.1660%, 0.1365%, 0.1260%, 0.1340%, and 0.1445%.

FIG. 12 depicts graphed 28-day water absorption percentages of the present grouts. Water absorption percentages were obtained on several different days. The ANSI A118.7.3.4 high standard is 5.00% as depicted in the graph. The results of the 28-day water absorption percentages show that all of the present grout compositions exhibited acceptable results falling below the ANSI A118.7.3.4 standard. In the graph of FIG. 12, the plotted water absorption percentages (from left to right) are as follows: 3.07%, 3.18%, 3.29%, 3.00%, 3.13%, 3.17%, 3.47%, 3.40%, 3.36%, 2.34%, 2.29%, 2.32%, 3.60%, 3.57%, 3.01%, 3.77%, 3.59%, 3.66%, 3.82%, 3.32%, 2.64%, 2.09%, 3.21%, 3.21%, 2.94%, 3.10%, 3.28%, 2.98%, 3.10%, 3.00%, 3.18%, 3.37%, 3.33%, 3.38%, 3.14%, 3.32%, 3.30%, 3.12%, 3.11%, 3.33%, 2.99%, 3.03%, 2.91%, 2.97%, 3.03%, 3.09%, 3.67%, 3.48%, 3.62%, 3.49%, 3.54%, 3.37%, 3.09%, 3.11%, 3.42%, 3.79%, 3.60%, 3.39%, 2.35%, 3.82%, 2.88%, 2.81%, 3.90%, 3.23%, 2.87%, 3.08%, 3.21%, 3.64%, 3.79%, 3.02%, 3.39%, 3.22%, 3.54%, 3.03%, 3.32%, 3.58%, 3.89%, 3.85%, 3.78%, and 3.69%.

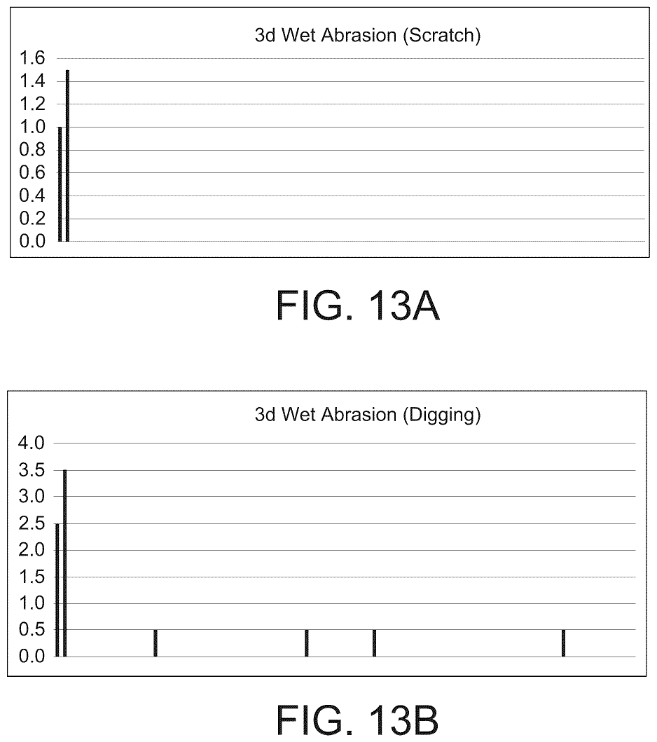

FIGS. 13A and 13B depict graphed 3-day wet abrasion testing of the present grouts. FIG. 13A depicts 3-day wet abrasion scratch testing of the present grouts, while FIG. 13B depicts 3-day wet abrasion digging testing of the present grouts. Again, rankings are performed on a grading system ranging from 0-5, with a “0” rank indicating no scratches occurring in the sample surface, and a “5” rank indicating that the grout was almost entirely removed from the grout joint. The graphs depict scratching and digging wet abrasion test rankings of current known grout compositions (i.e., 1.0 for scratching and 2.5 for digging). Also shown in the graphs are current industry standard rankings (according to Test Method W.I.9.1.81) that have an acceptable scratch resistance rank of 1.5 and digging resistance rank of 3.5. Referring to FIG. 13A, all 80 tested grout samples of the invention exhibited 0.0 (zero) rankings, which indicates no scratches occurred in such grout joints. FIG. 13B shows that only 4 out of the 80 tested grouts of the invention exhibited digging, each with ranks of merely 0.5. As such, all tested samples demonstrated excellent scratch and digging resistance to wet abrasion testing.

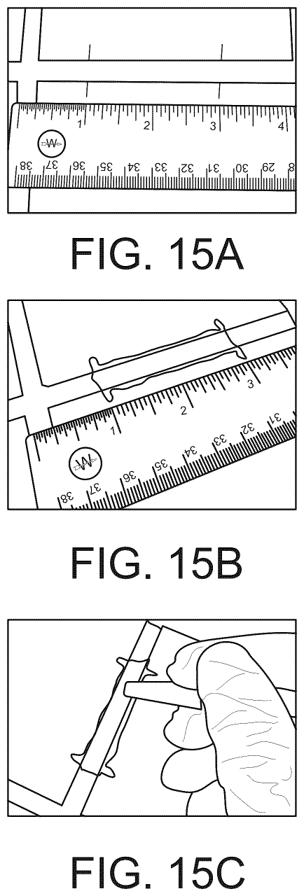

Additional testing was conducted on one or more grout formulations of the invention and compared to conventional grout materials. In doing so, wet abrasion testing for cement grouts were performed including both wet abrasion scratch testing and wet abrasion testing using a strength tester to determine strength (e.g., softness or hardness) of such grouts after cure and exposure to moisture/water. Referring to FIGS. 15A-15C, grout formulations of the invention and comparative prior art cement grouts were prepared and tested against each other. In doing so, prior art cement grouts were prepared and mixed per recommended mixing instructions. A preferred sand free cement-based grout composition of the invention was prepared. The prior art grouts and the sand free cement-based grout composition of the invention were applied to a test area comprising 4′×4′ tiles separated from each other by ¼″ grout joints/gaps and adhered to a cement back board using a cement adhesive or thinnest. The tested grouts were applied or deposited into different ¼″ grout joints/gaps, followed by washing.

After allowing the test areas to cure for 7 days, each cured prior art cement grout and the grout of the invention were tested for wet abrasion scratch testing. As shown in FIG. 15A each grout to be wet abrasion tested was measured and marked to a 2 inch long space, followed by applying 1 g (1 ml) of water to such marked along the pre-measured grout joint, as shown in FIG. 15B. The applied water was allowed to sit on the grout joint for 5 minutes. Referring to FIG. 15C, after the 5 minutes, the scratch testing was performed with the tester's hand resting on the mockup test area and the tip of a plastic spoon being used scratch the surface of the grout 5 times in a fluid and strong motion, while leaving the water in place to ensure the grout was being abrasion tested in a wet state.

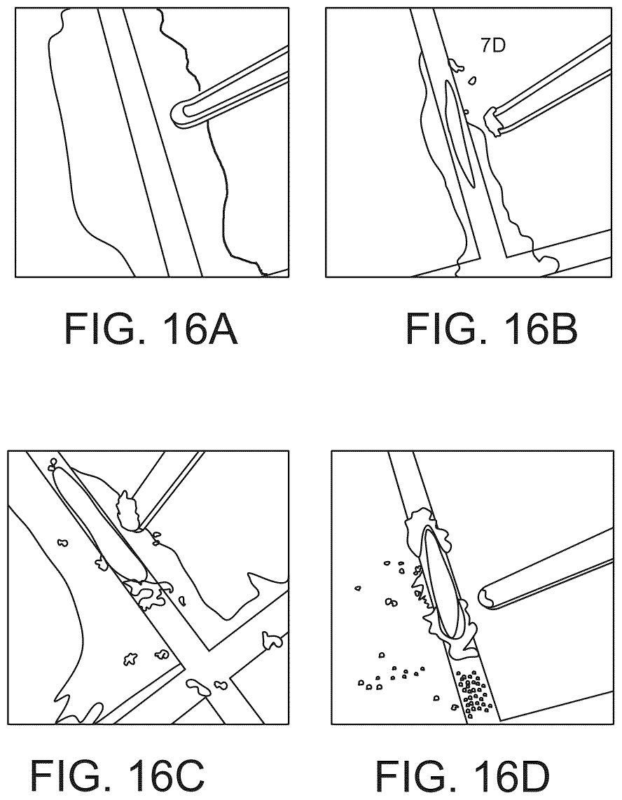

The wet scratch abrasion testing was graded based on the amount of abrasion/grout removal that has occurred on a scale of 0 to 5. A Grade 0 indicates that no mark (or barely any scratch) is observed on the surface. Referring to FIG. 16A, Grade 1 indicates a slight mark with very little removal of the grout has taken place on the surface. Grade 2, as shown in FIG. 16B, shows that the scratching has left a noticeable gouge in the surface of the grout. Referring to FIG. 16C, Grade 3 indicates that the scratching has left a bigger mark in the surface, and a bit of grout has been removed from the joint. Grade 4 is shown in FIG. 16D, which shows that the scratching has left a significant trench in the surface of the joint, and a lot of the grout has been removed from the joint. Grade 5 refers to almost all of the grout being very easily removed from the grout joint.

The wet abrasion testing using a strength tester was also performed to determine strength of the applied and cured grout in a wet state. The prior art cement grouts and grout of the invention were prepared and applied to a tiled test area as described above. However, in the wet abrasion strength testing the applied grouts were allowed to cure for 24 hours, or more preferably 3 days. The wet abrasion testing using a strength tester determines cementituous grout's ability to withstand/resist abrasion while it is being exposed to water/moisture.

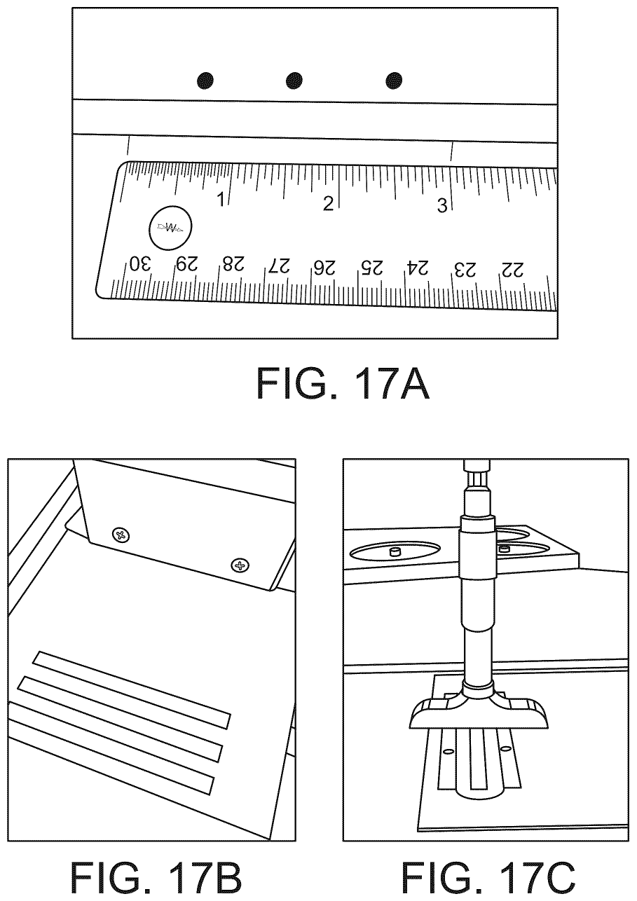

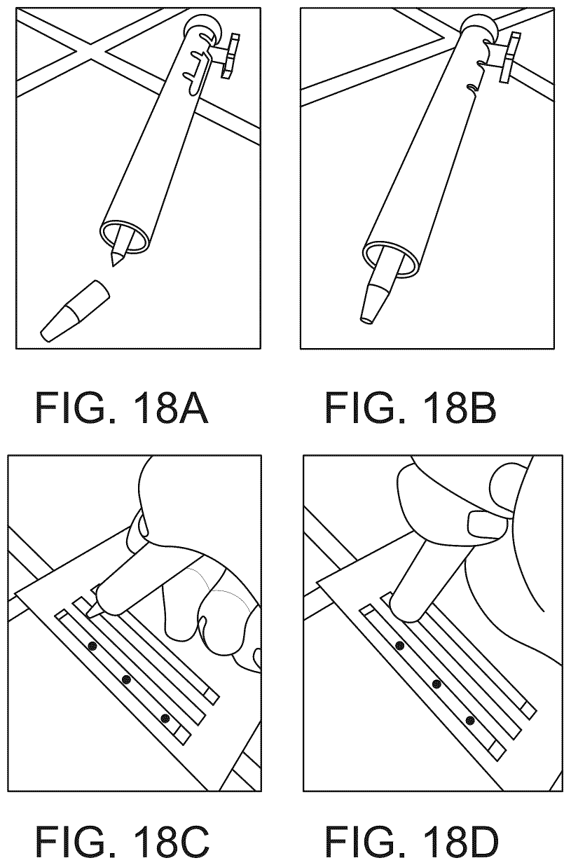

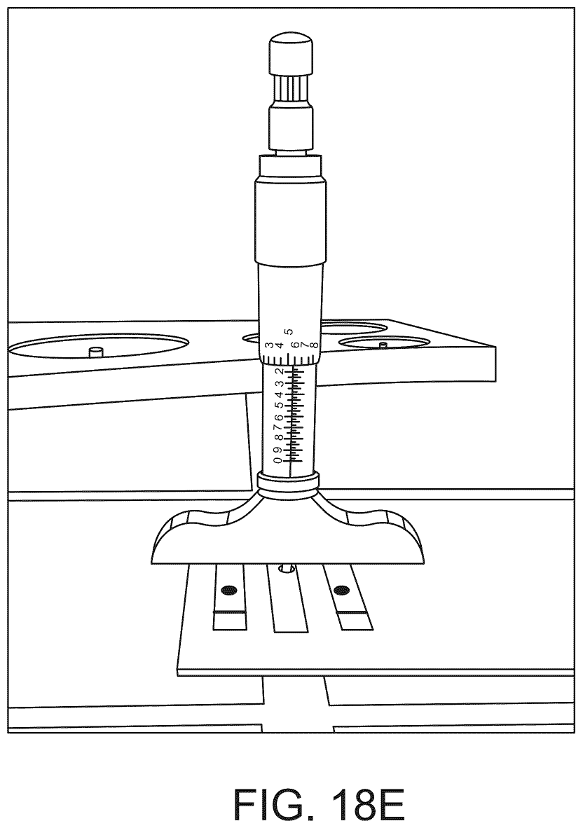

Referring to FIG. 17A, after curing the grout joints for 3 days, a 3″ (3 inch) space on the grout joint was measured with a ruler, and 3 spots marked on the tile, with the spots being spaced out along the line at 0.75″ intervals. Referring to FIGS. 17B and 17C, at each of the marked 0.75″ points drawn on the tile, a Strength Tester Guide (as shown in FIG. 17C) was used as a micrometer to determine the initial depth, for a total of 3 measurements per grout joint. The various marked grout sections are wet by applying 1 g (1 ml) of water along the pre-measured grout joint, and then the water was allowed to remain on the grout joint for 5 minutes. As shown in FIGS. 18A and 18B, a subfloor strength tester is prepared by ensuring that the 3D printed plastic tip is affixed to the sharp edge of the tester.

Referring to FIGS. 18C and 18D, after the water has sat on the grout joint for 5 minutes, any excess water remaining in or on the grout joint is removed or wiped away. Using a strength tester guide, the subfloor strength tester is used at a desired or preselected tension (e.g., for cementitious grouts the middle position is preferred), and pressure is applied on the strength tester so that the base of the tester is flush with the strength tester guide (as shown in FIG. 18D.) Once pressure is applied, using a fluid and strong motion, the strength tester is moved back and forth along the spaced out 3″ line for 5 full rotations (a rotation includes both back and forth movements). Referring to FIG. 12E, the wet abrasion testing using a strength tester is graded by placing the strength tester guide along the grout joint, and using a micrometer to measure the depth at each location/points along the grout joint that were previously taken before the abrasion (see FIG. 18E). The average difference from all 3 measurements is determined to be the wet abrasion measurement.

The wet abrasion test methods of FIGS. 15A to 18E were utilized to test various cement grouts known in the art as compared to a sand free cement-based grout composition in accordance with one or more embodiments of the invention. As is shown, the sand free cement-based grout composition of the invention exhibited superior wet abrasion digging, scratching, and strength testing, as compared to conventional grout compositions known in the art.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A sand free cement-based grout composition comprising:
calcium aluminate cement as a main binder present in an amount ranging from about 22-24 wt. %;
one or more additional binders present in an amount ranging from about 10-14 wt. %;
a single anhydrite binder present in an amount ranging from about 7-9 wt. %;
metakaolin present in an amount ranging from about 1.5-2.5 wt. %;
fine limestone present in an amount ranging from about 10-20 wt. %;
coarse limestone present in an amount ranging from about 25-45 wt. %;
an acidic retarder present in an amount ranging from about 0.30-0.60 wt. %;
a lithium-based accelerator present in an amount ranging from about 0.05-0.20 wt. %; and
wherein wt. % is based on a total weight of the grout composition.

2. The grout of claim 1 wherein the calcium aluminate cement comprises white calcium aluminate cement.

3. The grout of claim 1 wherein the single anhydrite binder comprises anhydrous calcium sulfate binder.

4. The grout of claim 1 further including a Portland Cement binder present in an amount ranging from about 3-5 wt. %.

5. The grout of claim 4 wherein the Portland Cement comprises White Ordinary Portland Cement.

6. The grout of claim 1 wherein the fine limestone comprises a fine 325 mesh crushed limestone.

7. The grout of claim 1 wherein the coarse limestone comprises a 40 mesh coarse limestone.

8. The grout of claim 1 wherein the acidic retarder comprises citric acid or tartaric acid.

9. The grout of claim 1 wherein the lithium-based accelerator comprises lithium carbonate or lithium sulfate.

10. The grout of claim 1 wherein the metakaolin comprises a highly reactive amorphous, alumino-silicate.

11. The grout of claim 1 further including a water dispersible powder present in an amount ranging from about 1.5-2.5 wt. %.

12. The grout of claim 1 further including a hydrophobic polymer present in an amount ranging from about 0.05-0.20 wt. %.

13. The grout of claim 1 further including a first rheology modifier comprising cellulose ether present in an amount ranging from about 0.05-0.10 wt. %.

14. The grout of claim 13 further including a second rheology modifier comprising fibers having a length of 3 mm or less present in an amount ranging from about 0.25-0.75 wt. %.

15. The grout of claim 1 further including a defoamer present in an amount ranging from about 0.25-0.30 wt. %.

16. The grout of claim 1 further including a water reducer comprising a superplasticizer present in an amount ranging from about 0.10-0.15 wt. %.

17. The grout of claim 1 further including a thickener comprising diutan gum present in an amount ranging from about 0.01-0.02 wt. %.

18. The grout of claim 1 further including a biocide present in an amount ranging from about 0.01-0.02 wt. %.

19. The grout of claim 1 further including a reinforcing fibers present in an amount ranging from about 0.01-0.02 wt. %.

20. The grout of claim 1 further including a colorant present in an amount ranging from about 0.005-6.0 wt. %.

21. A cured grout joint comprising the grout composition of claim 1 that remains intact under wet abrasion scratching and digging of said cured grout joint.
